(19) United States
(12) Patent Application Publication
(10) Pub. No.: US 2011/0127856 A1
(43) Pub. Date: Jun. 2, 2011

(54) MAGNETIC MONOPOLE ACCELERATOR

(76) Inventors: Georges Lochak, Paris (FR); Maurice Bergher, Bures sur Yvette (FR)

(21) Appl. No.: 13/055,059

(22) PCT Filed: Jul. 6, 2009
(86) PCT No.: PCT/FR09/51320

§ 371 Date: Jan. 20, 2011

(30) Foreign Application Priority Data
Jul. 23, 2008 (FR) 0855034

(51) Int. Cl. H02K 41/02

(52) U.S. Cl. 310/12.07

(57) ABSTRACT

An accelerator (1) of magnetic monopoles (10), the accelerator being characterized in that it comprises:
guide means (2) capable of guiding and optionally accelerating at least one magnetic monopole (10), said guide means defining an oriented main trajectory (3) followed by said magnetic monopole (10);
at least one inlet point (4) to said main trajectory (3) via which said magnetic monopole (10) is injected; and
at least one outlet point (5) on said main trajectory (3) from which said magnetic monopole (10) is ejected.

The present invention relates to an elementary particle accelerator capable of guiding and optionally accelerating a new type of particle: the magnetic monopole. A magnetic monopole is an elementary particle that carries a single magnetic charge.

In the field of particle accelerators, there exist numerous accelerators of a variety of sizes and powers. Until now, all elementary particles that are known or that are assumed to exist possess an electric charge or are electrically neutral. Known accelerators serve to act on particles that possess an electric charge, acting thereon by means of electric and/or magnetic fields.

A new type of elementary particle has been proven theoretically to exist. It is a particle that possesses a single magnetic charge or “pole” having a sign that may be north or positive (+), or else south or negative (−). Consequently, such a particle is called a magnetic monopole. It has been shown that another characteristic of such a monopole is that it has the nature of a lepton and that it presents zero mass. A magnetic monopole is also a neutrino. Another characteristic is that its magnetic charge is comparatively speaking 137 times greater than the electric charge of an electron.

Various experiments have made it possible to produce and reveal such monopoles practically. Monopoles are generally produced by means of a source delivering an electric discharge, e.g. using a battery of capacitors, into a liquid medium, often water. The presence of a monopole is revealed by characteristic tracks left on targets comprising photographic emulsions. Nevertheless, those known sources are isotropic and produce particles that are not focused and that have too little energy to enable them to be used.

In order to be able to study that particle to a greater extent, it needs to be possible to accumulate a quantity of such particles in the form of a beam, to store them, and to accelerate and focus them so as to make it possible to use a directed beam for bombarding a target or analysis means or indeed for organizing collisions between such particles. As for electrically-charged particles, an accelerator needs to be built that is capable of producing such beams.

It should be observed that the terms: “accelerator”, “accelerate”, and “acceleration”, are strictly speaking somewhat inappropriate, as is true of accelerators for electrically-charged particles. Since the particle has zero mass, its speed is already equal to the speed of light, which is the greatest speed that a material particle can achieve. The increase in acceleration to which the particle having mass would be subjected by a force is not observable for a monopole. Nevertheless, like accelerators for electrically-charged particles, the vocabulary in common use is conserved. When the term “acceleration” is used, it should be understood as meaning an increase in kinetic energy.

Applications for a beam of magnetic monopoles that is focused and directed are very numerous. In addition to applications in fundamental research, numerous practical applications are possible in a wide variety of fields: chemistry, biology, nuclear, etc. One example of an application is reprocessing radioactive substances.

The present invention proposes an accelerator device for guiding, concentrating, collimating, accelerating/increasing the energy of magnetic monopoles in order to be able to direct them towards an analysis target.

The invention provides a monopole accelerator, characterized in. that it comprises:
guide means capable of guiding and optionally accelerating at least one magnetic monopole, said guide means defining an oriented main trajectory followed by said magnetic monopole;
at least one inlet point to said main trajectory via which said magnetic monopole is injected; and
at least one outlet point on said main trajectory from which said magnetic monopole is ejected.

According to another characteristic of the invention, the guide means comprise at least one magnetic field generator means such that the main magnetic field lines coincide with said main trajectory and are all oriented in the same direction in the orientation of the main trajectory.

Alternatively, or in complementary manner, according to another characteristic of the invention, the guide means also comprise an electric field generator such that the electric field lines are perpendicular to the plane locally coinciding with the main trajectory, and are oriented in a manner that is consistent with the orientation of the main trajectory, in accordance with the Ampère-Maxwell equations.

According to another characteristic of the invention, the main trajectory is closed.

According to another characteristic of the invention, the accelerator further includes at least one monopole source disposed on the main trajectory at the inlet point.

According to another alternative characteristic of the invention, the accelerator further includes at least one monopole source that is not located on the main trajectory, and first injection guide means suitable for guiding monopoles of a first sign along a first injection trajectory from the first monopole source to the main trajectory at a first inlet point.

According to another characteristic of the invention, the accelerator further includes a target located on the main trajectory at the outlet point.

According to another alternative characteristic of the invention, the accelerator further includes at least a first target not located on the main trajectory and first ejection guide means suitable for guiding monopoles of a first sign along a first ejection trajectory from the main trajectory at a first outlet point to the first target.

According to another characteristic of the invention, the accelerator further includes at least one focusing means for focusing monopoles on the main trajectory.

According to another characteristic of the invention, the accelerator further includes an enclosure around the main trajectory and containing an inert gas or a vacuum.

The invention also provides a double accelerator comprising first and second accelerators in accordance with any of the above embodiments and each suitable for guiding, and optionally accelerating, monopoles of a respective sign.

According to another characteristic of the invention, both accelerators share a single monopole source.

Other characteristics, details, and advantages of the invention appear more clearly from the detailed description given below by way of indication and with reference to the drawings, in which:

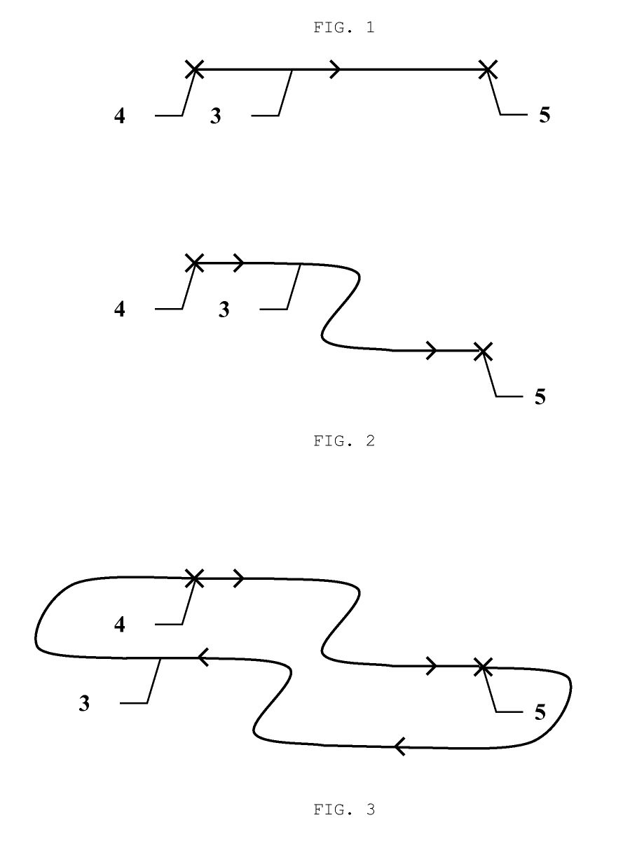

FIGS. 1 to 3 show examples of accelerator trajectory topologies;

FIG. 4 shows the principle whereby a monopole is guided and accelerated by a magnetic field;

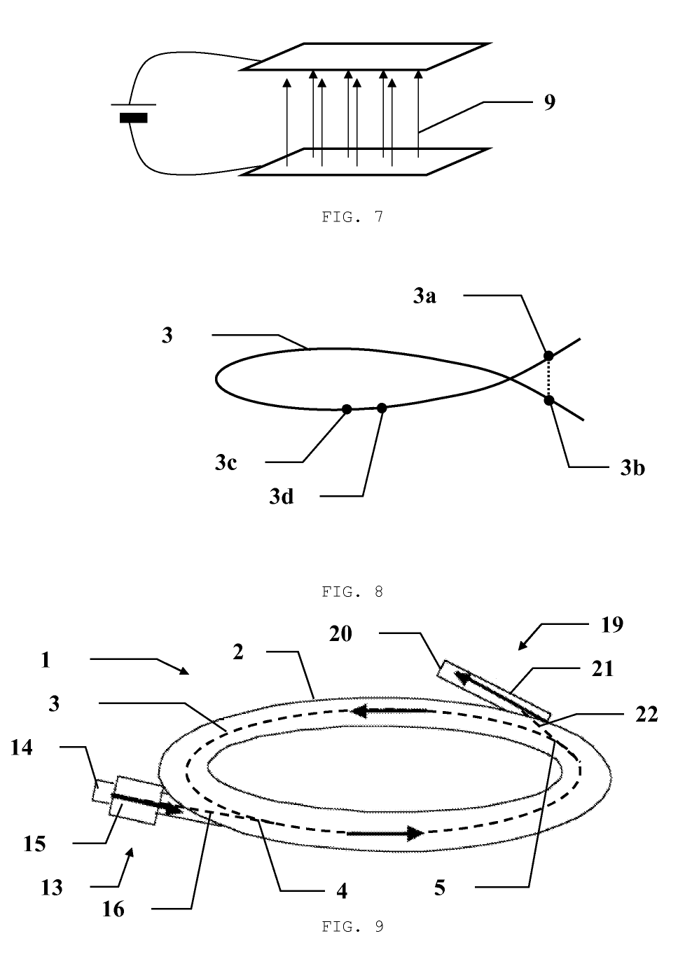

FIG. 5 shows the principle whereby a monopole is guided by an electric field;

FIG. 6 shows an example of a magnetic field generator;

FIG. 7 shows an example of an electric field generator;

FIG. 8 shows an advantageous topological property of the trajectory of an accelerator;

FIG. 9 shows a first embodiment of an accelerator;

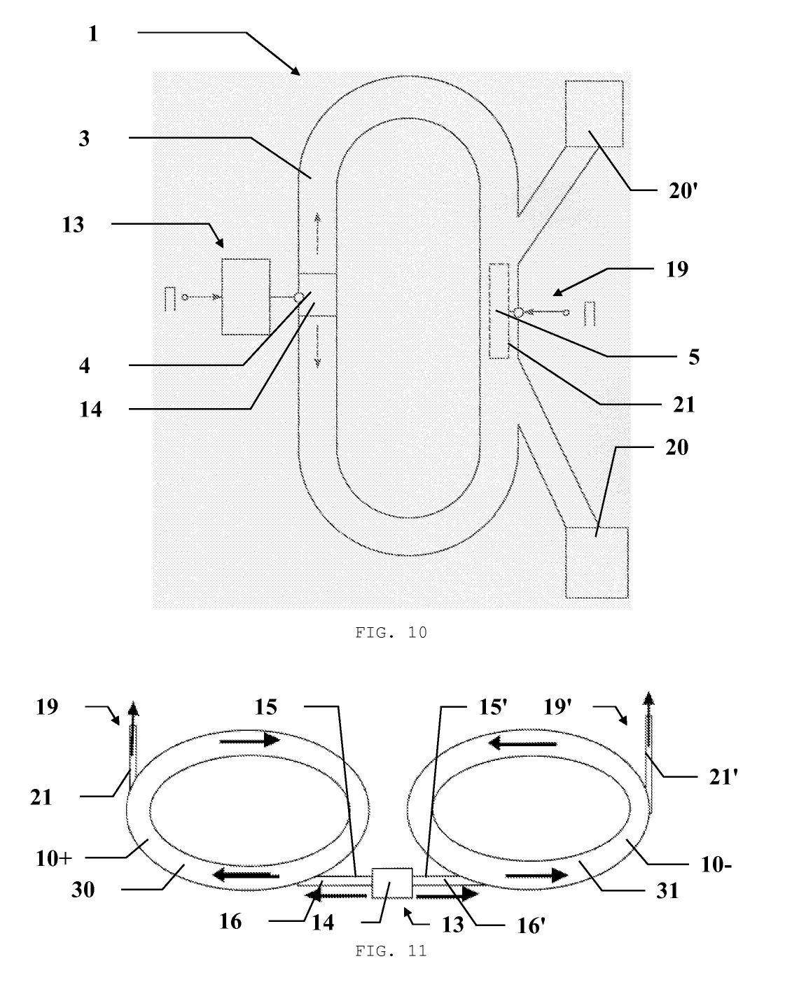

FIG. 10 shows a second embodiment of an accelerator;

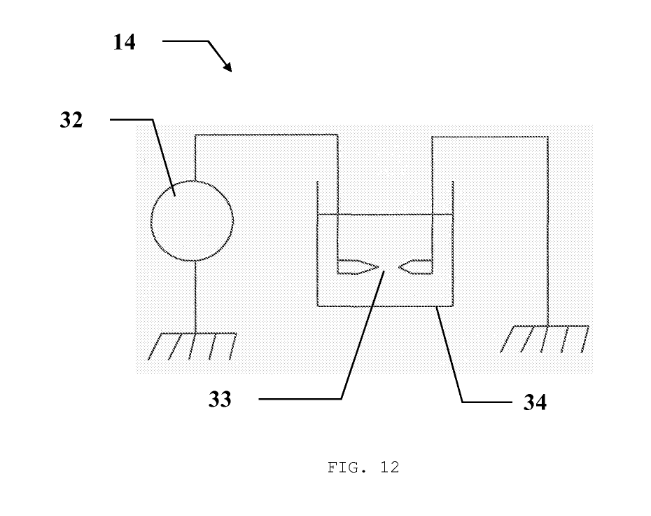

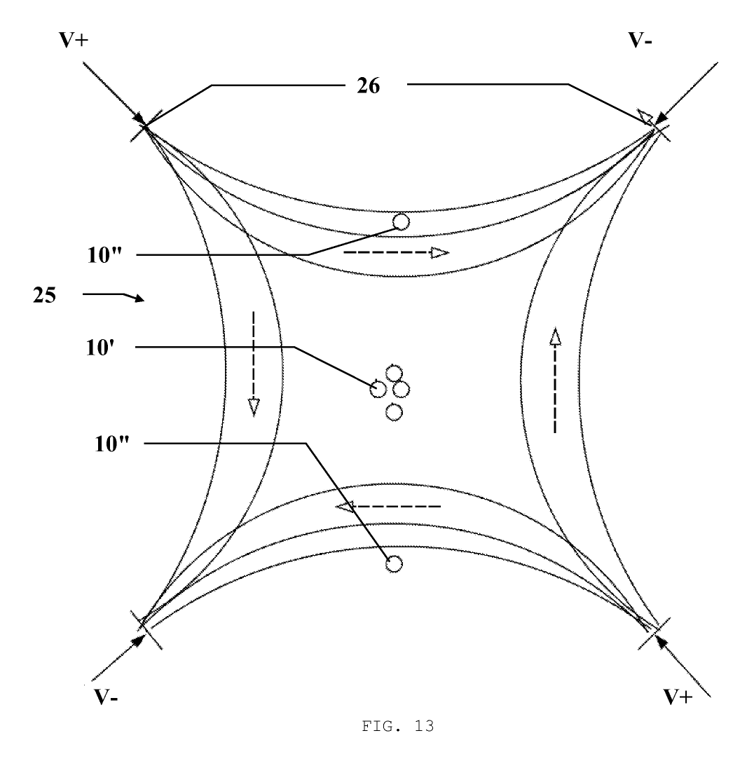

FIG. 11 shows a third embodiment of an accelerator;

FIG. 12 shows an embodiment of a monopole source; and

FIG. 13 shows focusing means.

The existence of magnetic monopoles has formed part of theory since they were revealed by one of the inventors, George Lochak, about thirty years ago. Their behavior in the presence of electromagnetic fields has been known for a long time from work on electromagnetic theory due to Maxwell and Ampère, amongst others.

More recently, certain experiments have made it possible, in the laboratory, to produce and to reveal magnetic monopoles. In order to be able to study them more deeply, it is appropriate to be able to produce them, to concentrate them, to store them, and to direct them. To do this, given that these particles are necessarily in motion, it is appropriate to guide them and to accelerate them so as to be capable of making a beam, and to project them against an analysis target so as to make them interact, e.g. with other particles, so as to characterize their behavior and their properties.

For this purpose, it is appropriate to construct a monopole accelerator 1. Since a monopole 10 is a particle that is always in motion, it cannot be stored statically. However it is possible to guide a monopole along an imposed trajectory. Such an accelerator 1 is shown in FIG. 9. Such an accelerator 1 comprises at least one guide means 2 that is capable of guiding, and where appropriate accelerating, said monopoles 10, said guide means 2 defining an oriented main trajectory 3 that is followed by said monopoles 10. On said trajectory 3, the accelerator 1 needs to include an inlet point 4 via which the monopole 10 can be introduced into the accelerator 1. In order to be able to make use of the monopole 10 as obtained in this way, or of the monopoles constituting a beam, the accelerator 1 needs to include an outlet point 5 on said trajectory 3 through which the monopole 10 or the beam can be extracted from the accelerator 1.

Various main trajectory topologies 3 can be envisaged as a function of the looked-for purpose. FIG. 1 shows a topology of the most simple kind, i.e. linear topology. The monopole 10 is guided, and where appropriate accelerated, along a main trajectory 3 that is rectilinear. Said main trajectory 3 is oriented along an axis that, as a function of the magnetic charge, determines the travel direction, here from left to right in the plane of the figure. Relative to the travel direction, it has an inlet or injection point 4 at its upstream end via which the monopole 10 can be introduced, and an outlet or ejection point 5 at its downstream end via which the monopole 10 can be extracted or ejected. The inlet and outlet points 4 and 5 may be situated at the ends of the trajectory 3.

It should be observed that the travel direction of the main trajectory 3 is determined by the orientation and the sign of the charge of the monopole 10. Thus, if a monopole 10+ of a first sign travels along the trajectory 3 in a first travel direction, identical to the orientation of the trajectory, then a monopole 10− of a second sign opposite to the first sign, will travel along the trajectory 3 in a second direction opposite to the first direction. It is then appropriate always to define the inlet point 4 and the outlet point 5 relative to each other so that the inlet point 4 is upstream from the outlet point 5 relative to the travel direction of the main trajectory 3.

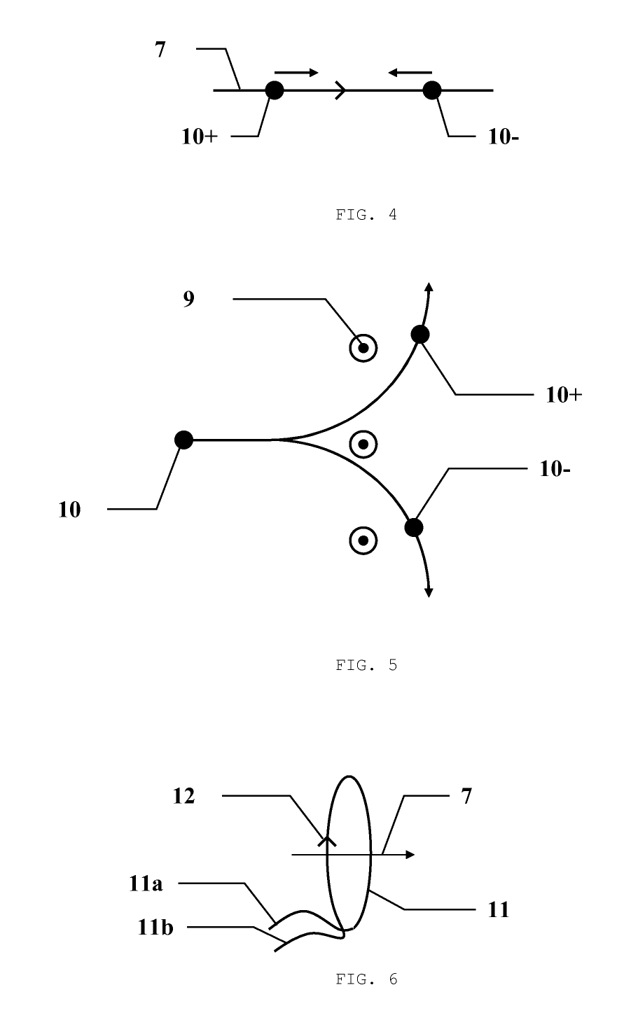

Any acceleration obtained for a monopole 10 is a function of the time passed along a magnetic field line 7, and thus depends on the length of said field line 7 or on the length of the main trajectory 3. In order to be able to increase the length of said main trajectory 3, without increasing the dimensions of the accelerator 1, it is advantageous to “roll up” the main trajectory 3. An example of a rolled-up main trajectory 3 is shown in FIG. 3.

FIGS. 1 and 2 represent plane topologies. It is naturally also possible to “roll up” the main trajectory 3 in three-dimensional space.

As is known from the principles of electromagnetism, and with reference to FIG. 4, a particle 10 having a magnetic charge with a first sign 10+ and placed in a magnetic field will follow the lines 7 of said field in a first travel direction. Furthermore, as it travels it will be accelerated (i.e. its energy will be increased) under the action of the magnetic field. A magnetically-charged particle of a second sign 10−, opposite to the first sign, and placed in the same magnetic field, will also follow the lines 7 of said field, but in the opposite direction in a second travel direction opposite to the first travel direction. This is represented by the arrows in FIG. 4. The exact travel directions may be determined by the Ampère-Maxwell law as a function of the orientation of the trajectory 3 and of the charge of the monopole 10.

Consequently, a magnetic field that is correctly configured to define a main trajectory 3 may serve simultaneously to guide and accelerate monopoles 10. Given the polarization and the fact that a single type/sign of monopole 10 is driven in a given travel direction, a magnetic field may also be used to sort monopoles 10 of one sign from amongst both signs in order to create one (or two) homopolar beam(s).

With reference to FIG. 5, a magnetically-charged particle 10 placed in an electric field will follow a trajectory 3 that is situated in a plane perpendicular to the electric field lines 9, which trajectory is substantially circular and centered on the electric field lines 9. In the figure, the electric field lines 9 are shown seen end-on. A dot in a circle represents the tip of an arrow. The plane perpendicular to the field lines 9 coincides in this figure with the plane of the figure. The particle 10 follows a magnetic equipotential curve. In so doing it is subjected to no acceleration and its energy does not increase. An electric field serves solely to deflect a magnetic particle 10. A magnetically-charged particle 10 of a first sign 10+ follows a magnetic equipotential curve in a first travel direction, describing in this example substantially a circle centered on said field line 9. A magnetically-charged particle having a second sign, opposite to the first sign, and placed in the same electric field will also follow a magnetic equipotential curve, i.e. a circle centered on said field line 9, but turning in the opposite direction in a second travel direction opposite to the first travel direction.

Consequently, an electric field that is correctly configured to define a main trajectory 3 may serve to guide/deflect monopoles 10. Given the polarization and the fact that only a single type/sign of monopole 10 is driven in a given travel direction, an electric field may also be used for sorting monopoles 10 of one of the two signs. Nevertheless, an electric field is not capable of accelerating monopoles 10. Since the purpose of the invention is to accelerate monopoles, or more exactly to increase their energy, acceleration is desired. The use of a magnetic field is fundamental and necessary for the invention. The use of an electric field is auxiliary and optional in that it does no more than deflect the particles.

On the basis of these principles, it is possible to construct an accelerator 1 by means of at least one magnetic field generator and/or at least one electric field generator, or any combination of generators of these two types.

In application of the laws of electromagnetism, the person skilled in the art knows various ways of constructing a magnetic field generator, and also the shape of the associated field lines 7.

A magnetic pole presenting radial field lines 7 about said pole, all of which are oriented either towards or away from said pole, thus serves to deflect attractively or repulsively a beam of monopoles 10 as a function of the comparison between the signs of the pole and of the monopoles 10. An electromagnet of axis perpendicular to the beam of the monopole 10, presenting field lines 7 that are substantially parallel between its two poles, also serves to deflect a beam of monopoles 10, as a function of their sign.

With reference to FIG. 6, and by way of example, an elementary generator is constituted by a turn 11 of conductive material. An electricity generator placed at the terminals 11a, 11b of said turn 11 for the purpose of creating a current 12 traveling around the turn 11 serves to create a magnetic field. The magnetic field presents. field lines 7 that are toroidal around the loop formed by the turn 11. In the center of the turn, this approximates to an axial field with rectilinear main field lines 7 extending perpendicularly to the plane of the turn 11. The orientation of the main field line 7 is determined by the Ampère-Maxwell law and depends on the direction in which the turn is wound (with a right-hand or left-hand pitch) and on the flow direction of the current 12.

It: should be observed that unlike FIG. 6, a turn 11 is not necessarily circular, but may have any looped shape.

The rectilinear approximation for the main field line 7 is particularly accurate when the turn 11 is placed together with other adjacent turns 11 that are substantially parallel in pairs, with their centers extending along a continuous trajectory and oriented in consistent manner.

By using the property of an individual turn 11, it is possible to construct a magnetic field generator means 6 serving to determine an arbitrary main trajectory 3. For a given main trajectory 3, it is appropriate to make a coil that winds in centered manner around the main trajectory 3, its turns 11 being substantially perpendicular to said main trajectory 3, said coil conveying a direct current (DC) oriented consistently with the orientation of the main trajectory in application of the Ampère-Maxwell equations.

Such a coil is particularly advantageous in that the shape of the magnetic field at the core of the coil provides guidance for monopoles 10. By producing a magnetic field, the coil accelerates the monopoles 10. The coil is easy to make by following the main trajectory 3.

Furthermore, it is simple to space apart a few turns 11 of such a coil without excessively disturbing the magnetic field, so as to provide an opening for receiving an injector 13 or an ejector 19.

A consistent orientation of two adjacent turns may be obtained with both turns having the same winding direction and both conveying a current in the same direction, or with the winding direction changing between the first turn and the second turn and simultaneously with the direction of the current 12 also changing.

It is also possible to use turns 11 that are concentric of diameters that are equal or different.

Similarly, it is possible to combine various coils that may be mixed together (same winding direction) or mutually crossed (different winding directions).

If the orientations are consistent, the intensities of the magnetic fields produced by the various turns 11 add together. It is possible to combine the various embodiments, turns in the same direction, alternating turns, concentric turns, mixed coils, crossed coils.

By using such turns/coils, it is possible to define a main trajectory 3 that is linear or curved. In order to follow the curvature of the trajectory, the turns 11 are all parallel to the trajectory in their centers. In order to ensure that two adjacent turns 11 remain substantially parallel, it is preferable for the main trajectory 3 to satisfy certain characteristics concerning continuity or differentiability. These same characteristics avoid having “accidents” on the main trajectory 3 that are too abrupt, thus making it easier to guide the beam of monopoles 10.

As mentioned above, it is also possible to deflect a beam of monopoles 10 by using an electric field.

In application of the laws of electromagnetism, the person skilled in the art knows various ways of constructing an electric field generator 8 and the shape of the associated field lines 9, and also the trajectory that will be followed by a particle passing through the electric field.

By way of example, and with reference to FIG. 7, an elementary generator 8 is constituted by a capacitor that is constituted in conventional manner by two plates.

The application of a potential difference between said plates creates an electric field having field lines 9 that are rectilinear, mutually parallel, and that connect the two plates together. In such an electric field, monopoles are deflected to follow circular trajectories winding around the field lines 9, as shown in detail with reference to FIG. 5.

The main trajectory 3 is advantageously continuous.

The main trajectory 3 advantageously presents a continuous radius of curvature R regardless of whether it is defined by a magnetic field generator and/or by an electric field generator.

In the above-mentioned approximation, no account is taken of the magnetic field lines that exist outside a turn 11. The magnetic field lines outside the coil do not risk disturbing the accelerator 1.

For an optionally circular and substantially plane turn 11, it is possible to determine an equivalent radius rₑ using the following formula:

$${r}_{e} = \sqrt{\frac{S}{Π}}$$

where s is the surface area projected by the turn on the plane perpendicular to the main trajectory and intersecting the turn, and where π is the trigonometric ratio. It is advantageous for the ratio of the radius of curvature R to the equivalent radius rₑ to be greater than 10 for all of the turns, i.e.:

$$\frac{R}{{r}_{e}} > 10$$

all along the main trajectory 3.

Another advantageous property of the main trajectory 3 is described with reference to FIG. 8. The main trajectory 3 may be “folded” over either in the plane or indeed in three dimensions. Nevertheless, this “fold” must not be too great. Thus, two branches of the trajectory 3 on approaching each other or crossing each other should preferably conserve some minimum distance between them that is equal to not less than two equivalent radii rₑ. FIG. 8 shows a portion of main trajectory 3 that is folded over and that presents two branches that cross. The point 3a on the first branch and the point 3b on the second branch are the points where the two branches are the closet together. It is appropriate for the distance between these two points to be not less than 2rₑ. The condition applies to any pair of points except when the two points of the pair are directly connected by the main trajectory 3. Thus, adjacent points 3c and 3d that are connected together by the trajectory 3 may be spaced apart by less than 2rₑ.

Advantageously, and as shown in FIG. 3, the main trajectory is closed. This makes it possible to form a loop or ring in which the monopoles 10 can be stored until they are ejected. In addition, this makes it possible to create a main trajectory 3 of infinite length, enabling the monopoles 10 to be accelerated so long as they are circulating around the main trajectory 3, while conserving an accelerator 1 of small dimensions.

With reference to FIG. 9, there follows a description of an embodiment of an accelerator 1. The main trajectory 3 is elliptical in this example and it is in the form of a loop. It could equally well be circular. It is defined by guide means 2. By way of example, the guide means 2 comprise a coil wound around the trajectory 3, for generating a magnetic field 6. Under such circumstances, the guide means are also suitable for accelerating the monopoles 10 that follow the trajectory 3. A monopole injector 13 serves to inject at least one monopole 10 onto the trajectory 3 at the inlet or injection point 4. The injector 13 comprises a source 14 and injection guide means 15 for injection along an injection trajectory 16. A monopole ejector 19 serves to eject at least one monopole 10 from the trajectory 3 at the outlet or ejection point 5. The ejector 19 comprises ejection guide means 21 for providing guidance along an ejection trajectory 22, and a target 20.

Nowadays, at least three devices are known that enable monopoles to be created. FIG. 12 shows details of one embodiment of a source 14. An electricity generator 32 producing direct current at 100 volts (V) and 40 amps (A) is connected to a spark gap 33 immersed in a vessel containing a liquid, typically water. When the spark occurs between the two electrodes of the spark gap 33, monopoles are produced.

The term source 14 is used to designate any device capable of producing magnetic monopoles 10. Known sources produce monopoles of positive (+) and negative (−) signs simultaneously. These particles are emitted uniformly in all directions. Nevertheless, in the presence of a magnetic field, which is necessarily oriented, the monopoles of the two types (+ and −) are distinguished between, forming homopolar beams, the monopoles of a first sign being guided along the trajectory 3 in a first travel direction while any monopoles of the second sign, opposite to the first, are guided along the trajectory 3 in a second travel direction opposite to the first direction.

In a first embodiment, a source 14 is placed on the main trajectory 3 so that the point at which monopoles are produced coincides with the inlet point 4. Since both types of monopoles are produced when the source 14 is active, the magnetic field defining the trajectory at the inlet point 4 guides monopoles of a first type (+) along the trajectory 3 in a first direction and it guides the monopoles of a second type (−) along the trajectory 3 in a second direction opposite to the first direction. A distinction is thus made between the monopoles 10 on the basis of their type.

For an accelerator 1 that is looped in a ring, the ring thus stores monopoles of a first type 10+ going round it in a first direction and monopoles of an opposite, second type 10− going round it in a second direction opposite to the first direction. It is then possible for collisions to occur.

FIG. 10 shows this embodiment of an accelerator 1. The injector 13 is such that the single source 14 is located at the inlet point 4 on the trajectory 3. Both types of monopole 10 are thus produced directly on the trajectory. Given the presence of oriented guide means 2 all along the trajectory 3, and thus also at the inlet point 4, the monopoles 10 are therefore guided immediately depending on their sign in one direction or the other, as represented by the two arrows. Since the main trajectory 3 in this example is looped, the monopoles can be stored in the ring formed in this way, with both types of monopoles 10 sharing the same ring, but traveling round it in opposite directions.

This embodiment, with the source 14 on the trajectory 3 presents the advantage of making it simple to inject monopoles into the accelerator 1. There is no need to provide injection guidance. A drawback of this embodiment, with a trajectory that is looped, is that the beam of monopoles 10 needs to pass through the source 14 once again each time it passes through the inlet point 4. A variant, that reduces this drawback, consists in retracting the source 14 from the main trajectory 3 after monopole production.

In a second embodiment, a monopole source 14 is located outside the main trajectory 3. This is shown for example in FIG. 9 or 11. In order to make a monopole injector 13, it is then necessary to associate the source 14 with injection guide means 15 suitable for guiding the monopoles 10 along an injection trajectory 16 connecting the monopole source 14 to the main trajectory 3 via the inlet point 4.

Like the main guide means 2, the injection means 15 comprise a combination of magnetic and/or electric field generator means. They thus distinguish between monopoles in terms of sign and guide monopoles 10 of only one type.

The embodiment with a source 14 outside the main trajectory 3 is advantageous if it is desired to guide, accelerate, or store monopoles of one single type only. Another advantage is that the source 14 is not on the main trajectory 3 and the beam does not pass through it on each pass.

If, as in the embodiment with a source 14 on the main trajectory 3, it is desired to have monopoles 10 of both types, it is appropriate to use a second source 14′ in addition to the above-mentioned source 14. This second source 14′ may coincide with the first source 14, since a source produces monopoles of both signs simultaneously. Second injection guide means 15′ are oriented so as to guide monopoles of a second sign opposite to the monopoles of the first sign that are guided by the first injection guide means 15 associated with the first source 14 and they serve to filter the monopoles of the second sign and to guide them from the second source 14′ to the main trajectory 3 at a second inlet point 4′. Depending on the configuration, this second inlet point 4′ may likewise coincide with the first inlet point 4.

Advantageously, in order to facilitate admission of monopoles 10 onto the main trajectory 3, the first and second injection guide means 15 and 15′ are devised in such a manner that the first and second injection trajectories 16 and 16′ are tangential to the main trajectory 3 at the first and second inlet points 4 and 4′, respectively.

Like the guide means 2 of the main trajectory 3, guidance along the injection trajectory 16 may be implemented by at least one magnetic field generator, at least one electric field generator, or a combination of both types of generator.

Also advantageously, in order to limit the disturbances to the main magnetic or electric guide field at the inlet point 4, 4′, the injection guide means 15 are controllable so as to be capable of being interrupted when no injection is being performed. Thus, for example, the current used by the first field generator to produce said field is advantageously switched off once injection has been performed.

It should be observed that if the main guidance on the main trajectory 3 at the inlet point 4 is provided by a magnetic field generator or an electric field generator, respectively, it is advantageous to provide the injection guidance in the vicinity of the inlet point 4, 4′ using an electric field generator or a magnetic filed generator, respectively. Changing the electric/magnetic type of field in this way makes it possible to avoid, or at least to limit, the mutual disturbances between the two adjacent field generator means.

The purpose of an accelerator 1 of the invention is to make it possible to direct a beam of monopoles 10 towards a target 20 or analysis means.

The term “target” 20 is used to designate any device capable of sensing, receiving, stopping, analyzing, or being modified by interacting with a monopole. It may be a photographic plate, a bubble chamber, a test piece made of reactive material, etc.

In a first embodiment, a target 20 is placed on the main trajectory 3 so as to intercept the monopole beam at the outlet point 5. A target is necessary for analyzing monopoles except when collisions are implemented between monopoles 10.

This embodiment, with the target 20 on the trajectory 3 presents the advantage of making it simple to eject monopoles from the accelerator 1. There is thus no need to provide ejection guidance. A drawback of this embodiment, when the trajectory is looped, is that the beam of monopoles 10 needs to pass through the target 20 each time it passes the outlet point 5. In a variant that reduces this drawback, the target 20 is retracted from the main trajectory throughout the stage of storing/accelerating monopoles, and is introduced therein only when it is desired to proceed with analysis.

In a second embodiment, the target 20 is located outside the main trajectory 3. This is shown in FIGS. 9, 10, and 11. In order to provide a monopole ejector 19, it is then necessary to associate the target 20 with ejection guide means 21 suitable for guiding the monopoles 10 along an ejection trajectory 22 connecting the main trajectory 3 at the outlet point 5 to the target 20.

Like the main guide means 2 or the injection guide means 15, the ejection guide means 21 comprise a combination of magnetic and/or electric field generator means. It thus serves to distinguish monopoles in terms of sign and to guide monopoles 10 of one type only.

The embodiment with a target 20 outside the main trajectory 3 is advantageous if monopoles of both types are being guided together. It should be observed that monopoles of opposite signs are guided in opposite directions in an accelerator. The selective ejector 19 makes it possible to eject only monopoles 10 of one particular sign. Another advantage is that the target 20 is not on the main trajectory 3 and therefore does not have the beam passing therethrough on each pass.

If the accelerator 1 guides monopoles of both types, it is appropriate to use a second ejector 19′ in addition to the first ejector 19. The second ejector 19′ may coincide with the first ejector 19. Second ejection guide means 21′ are oriented so as to guide monopoles of a second sign opposite to monopoles of the first sign that are guided by the first ejection guide means 21 associated with the first ejector 19 and they serve to filter monopoles of the second sign and to guide them from the main trajectory 3 to a second target 20′ from a second outlet point 5′. Depending on the configuration, the second outlet point 5′ may coincide with the first outlet point 5.

In an advantageous embodiment shown in FIG. 10, a single ejector 19 suitably positioned at a single outlet point 5 makes use of single ejection guide means 21 serving to guide in symmetrical manner firstly monopoles of a first sign coming from the ring (from the top of FIG. 10) into a first ejection channel leading to a first target 20, and also monopoles of an opposite second sign coming from the ring (from the bottom of FIG. 10) into a second ejection channel leading to a second target 90′.

Advantageously, in order to facilitate extracting monopoles 10 from the main trajectory 3, the first and second ejection guide means 21 and 21′, respectively, are arranged in such a manner that the first and second ejection trajectories 22 and 22′, respectively, are tangential to the main trajectory 3 at the first and second outlet points 5 and 5′, respectively.

Like the guide means 2 of the main trajectory 3, and the guide means 15 of the injection trajectory 16, guidance along the ejection trajectory 22 may be provided by at least one magnetic field generator means, at least one electric field generator means, or a combination of both types of generator means.

Also advantageously, in order to limit disturbances to the main magnetic or electric guide field at the outlet point 5, 5′, the ejection guide means 21 are controllable so as to be capable of being interrupted when no injection is being performed. Thus, for example, the current used by the injection field generator means to produce said field is advantageously interrupted so long as no ejection is being performed.

It should be observed that if the main guidance on the main trajectory 3 at the outlet point 5, 5′ is provided. by magnetic or electric field generator means, respectively, it is advantageous to implement injection guidance in the vicinity of the outlet point 5, 5′ with electric or magnetic field generator means, respectively. Such a change in the electric/magnetic field type serves to avoid, or at least to limit, mutual disturbances between the two adjacent field generator means.

Like neutrinos, magnetic monopoles 10 interact little with any atoms or molecules that they might encounter as they travel along the trajectory 3, 16, 22. Unlike electric particle accelerators, there is therefore no need to establish a vacuum around the trajectory. Although a few centimeters of air suffice to stop an electron, a magnetic monopole passes through several meters of air without problem. Thus, diffusion of the beam as a result of the air contained in the accelerator 1 does not disperse the beam of monopoles 10.

Nevertheless, it may be necessary to concentrate the beam by focusing the monopoles 10 in order to compensate for beam dispersion, whatever its origin.

In order to simplify guidance during injection or ejection, it may also be advantageous to concentrate the beam.

For this purpose, the accelerator 1 advantageously includes at least one monopole focusing means 25 placed on the main trajectory 3.

Such focusing means 25 may be made on the basis of at least, one electric quadrupole 26. FIG. 13 shows an example of focusing means 25. These means are constituted by a quadrupole 26. Such a quadrupole 26 has four electric poles placed in alternation at positive potential V+ and at negative potential V−. The quadrupole 26 is arranged so as to be centered around the trajectory. Thus, a monopole 10′ traveling along said trajectory remains collimated. In contrast, a monopole 10″ that is located eccentrically relative to said trajectory, finds itself deflected by the effect of the field produced by the quadrupole 26 so as to return to the center of the focusing means 25 and thus to the trajectory.

For better efficiency, the focusing means 25 are preferably located in a rectilinear portion of the main trajectory 3 or where appropriate of the injection trajectory 16 or of the ejection trajectory 22.

As described above, an accelerator 1 of the invention can operate in ambient air. Nevertheless, depending on the dimensions of the trajectory 3, given the voltages that are needed by the various magnetic or electric generator means, and by said focusing means 25, which voltages may be high, it is possible that the air might become ionized. In order to remedy such ionization, the accelerator may advantageously include an enclosure around the main trajectory 3 and, where appropriate, around the injection and/or ejection trajectory 16 and/or 22, which enclosure contains an inert gas 28. By way of example, the inert gas 28 may be SF₆. An alternative is to evacuate the enclosure.

A particular configuration, shown in FIG. 11, has a first accelerator 30 in accordance with any of the above-described embodiments suitable for guiding and optionally accelerating monopoles of a first sign 10+ and a second accelerator 31 in accordance with any of the above-described embodiments that is suitable for guiding, and optionally accelerating, monopoles of a second sign 10−. The two accelerators 30, 31 advantageously share a single source 14 of monopoles. Two injection guide means 15, 15′ serve to separate the monopoles according to their signs and to inject them respectively into the first accelerator 31 or the second accelerator 32.

1. An accelerator ROM of magnetic monopoles, the accelerator comprising:
guide means capable of guiding and optionally accelerating at least one magnetic monopole, said guide means defining an oriented main trajectory followed by said magnetic monopole, and having at least one magnetic field generator means such that the main magnetic field lines coincide with said main trajectory and are all oriented in the same direction in the orientation of the main trajectory;
at least one inlet point to said main trajectory via which said magnetic monopole is injected; and
at least one outlet point on said main trajectory from which said magnetic monopole is ejected.

2. An accelerator according to claim 1, wherein the guide means further comprise an electric field generator such that the electric field lines are perpendicular to the plane locally coinciding with the main trajectory, and are oriented in a manner that is consistent with the orientation of the main trajectory, in accordance with the Ampère-Maxwell equations.

3. An accelerator according to claim 1, wherein said magnetic field generator means has at least one coil wound around the main trajectory with its turns being substantially perpendicular to the main trajectory and conveying a direct current that is oriented in a manner that is consistent with the orientation of the main trajectory, in accordance with the Ampère-Maxwell equations.

4. An accelerator according to claim 1, wherein the main trajectory presents a radius of curvature R that is continuous.

5. An accelerator according to claim 3, wherein the equivalent radius rₑ of a turn, as defined by the formula:
$${r}_{e} = \sqrt{\frac{S}{Π}}$$
where s is the surface area of the turn projected onto a plane perpendicular to the main trajectory and intersecting the turn, is such that the ratio of the radius of curvature R to the equivalent radius rₑ is much greater than 1 for all of the turns, i.e.:
$$\frac{R}{{r}_{e}} ≫ 1$$

6. An accelerator according to claim 3, wherein the main trajectory is folded over in such a manner that no two points of the main trajectory are less than 2rₑ apart from each other unless they are directly adjacent and connected along the main trajectory.

7. An accelerator according to claim 1, wherein the main trajectory is closed.

8. An accelerator according to claim 1, further comprising at least one monopole source disposed on the main trajectory at the inlet point.

9. An accelerator according to claim 1, further comprising a first monopole source that is not located on the main trajectory and first injection guide means suitable for guiding monopoles of a first sign along a first injection trajectory from the first monopole source to the main trajectory at a first inlet point.

10. An accelerator according to claim 9, further comprising a second monopole source that is not located on the main trajectory, possibly coinciding with the first monopole source, and second injection guide means suitable for guiding the monopoles of a second sign along a second injection trajectory from the second monopole source to the main trajectory at a second inlet point.

11. An accelerator according to claim 9, wherein the first and second injection guide means respectively are such that the first and second trajectories respectively for injecting monopoles at the first and second inlet points respectively are tangential to the main trajectory.

12. An accelerator according to claim 9, wherein the first and second injection guide means respectively have magnetic field generator means having main magnetic field lines connecting the first and second monopole sources respectively to the first and second inlet points respectively on the main trajectory and present orientations that are consistent with the orientation of the main trajectory.

13. An accelerator according to claim 9, wherein the first and second injection guide means respectively have electric field generator means having main electric field lines perpendicular to the planes that locally coincide with the main trajectory at the first and second inlet points respectively, and that are oriented in manners that are consistent with the orientation of the main trajectory in accordance with the Ampère-Maxwell equations.

14. An accelerator according to claim 1, further comprising a target located on the main trajectory at the outlet point.

15. An accelerator according to claim 1, further comprising a first target not located on the main trajectory, and first ejection guide means suitable for guiding monopoles of a first sign along a first ejection trajectory from the main trajectory at a first outlet point to the first target.

16. An accelerator according to claim 15, further comprising a second target not located on the main trajectory, and second ejection guide means suitable for guiding monopoles of a second sign along a second ejection trajectory from the main trajectory at a second outlet point to the second target.

17. An accelerator according to claim 15, wherein the first and second ejection guide means respectively are such that the first and second monopole ejection trajectories respectively at the first and second outlet points respectively are tangential to the main trajectory.

18. An accelerator according to claim 15, wherein said first and second ejection guide means respectively have a first magnetic field generator having main magnetic field lines connecting the first and second outlet points respectively on the main trajectory to the first and second targets respectively and present orientations that are consistent with the orientation of the main trajectory.

19. An accelerator according to claim 15, wherein said first and second ejection guide means respectively have electric field generator means having main electric field lines that are perpendicular to the plane that locally coincides with the main trajectory at the first and second outlet points respectively, and that are oriented in manners that are consistent with the orientation of the main trajectory in accordance with the Ampère-Maxwell equations.

20. An accelerator according to claim 1, further comprise at least one focusing means for focusing monopoles on the main trajectory.

21. An accelerator according to claim 1, further comprising at least one focusing means for focusing monopoles on the injection trajectory or on the ejection trajectory.

22. An accelerator according to claim 20, wherein said focusing means has at least one electric quadrupole.

23. An accelerator according to claim 20, wherein said focusing means are disposed in a rectilinear portion of the trajectory.

24. An accelerator according to claim 1, further comprising an enclosure around the trajectory and containing an inert gas.

25. An accelerator according to claim 1, further comprising an evacuated enclosure around the trajectory.

26. A double accelerator comprising:
a first accelerator according to claim 1 suitable for guiding and optionally accelerating monopoles of a first sign; and
a second accelerator according to claim 1 suitable for guiding and optionally accelerating monopoles of a second sign.

27. A double accelerator according to claim 26, wherein both accelerators share a single monopole source.
